(19) United States
(12) Patent Application Publication
(10) Pub. No.: US 2007/0199557 A1
(43) Pub. Date: Aug. 30, 2007

(54) Dual Baking/Cooking Camping Appliance

(76) Inventor: William E. von Kaenel JR., Fresno, CA (US)

Correspondence Address: PATENT LAW OFFICES OF MICHAEL E. WOODS, 3433 WHEELING DRIVE, SANTA CLARA, CA, 95051, US

(21) Appl. No.: 11/307,829

(22) Filed: Feb. 24, 2006

(51) Int. Cl. A47J 37/00

(52) U.S. Cl. 126/25 R

(57) ABSTRACT

A system and method for a portable, space and weight efficient cooking solution that permits baking and other alternative cooking solutions. The system includes a heat conductive container having a container bottom and a container sidewall extending upwardly from the container bottom to form a container opening; a container lid generally sealing the container opening, the container lid including a double-wall defining a space including one or more vents communicated outside the container; and a heat-conducting chimney, communicated through the container bottom into the space of the container lid when the container lid seals the container, for conducting combustion gases from the open flame when the flame is proximate the container bottom through the container without the combustion gasses entering into the container, the combustion gasses entering into the space and exiting through the one or more vents.

### BACKGROUND OF THE INVENTION

The present invention relates generally to outdoor cooking, and more particularly to outdoor baking using cookware designed for backpack use.

Outdoor cooking equipment for backpackers continues to be innovated to provide greater flexibility than simply boiling a small pot of water over a gas burner that is used to reconstitute freeze-dried food. There is a pair of seemingly contradictory goals for backpackers: 1) expand upon a menu and range of cooking options available to a backpacking chef, and 2) lighten a load and bulk of equipment of all types used in the course of a backpack excursion.

Many backpackers are beginning to realize and request alternatives to reconstituted freeze-dried meals. For example, the current state of the art provides a special purpose backpack compatible baking solutions that typically also require traditional cooking pots.

One system is called the Backpacker's Pantry Outback Oven. It consists of a simple nonstick-coated frying pan and lid, plus a heat diffuser that raises the pan from the stove burner to prevent scorching and an aluminized fiberglass dome that fits over the oven to trap and circulate heat. A thermometer built into the lid handle helps keep the cooking temperature at the desired level. The Outback Oven does add weight to the pack, and the user still needs to carry regular cook pots.

Other less relevant solutions include use of a non-stick fry-back pan with a snug fitting lid. Some solutions have used a source of bottom heat (a campfire or gas burner) and built a small twiggy fire on top. Another solution is to provide for an aluminum rack to be installed inside a pot in order to “steam bake” by covering and heating the pot. Yet another solution includes constructing a makeshift oven using metal panels assembled over a heat source.

What is needed is a portable, space and weight efficient cooking solution that permits baking and other alternative cooking solutions.

### BRIEF SUMMARY OF THE INVENTION

Disclosed is a system and method for a portable, space and weight efficient cooking solution that permits baking and other alternative cooking solutions. The system includes a heat conductive container having a container bottom and a container sidewall extending upwardly from the container bottom to form a container opening; a container lid generally sealing the container opening, the container lid including a double-wall defining a space including one or more vents communicated outside the container; and a heat-conducting chimney, communicated through the container bottom into the space of the container lid when the container lid seals the container, for conducting combustion gases from the open flame when the flame is proximate the container bottom through the container without the combustion gasses entering into the container, the combustion gasses entering into the space and exiting through the one or more vents.

The method includes a) supporting a container over an open flame, the container including: a heat conductive wall defining a container bottom and a container sidewall extending upwardly from the container bottom to form a container opening; a container lid generally sealing the container opening, the container lid including a double-wall defining a space including one or more vents communicated outside the container; and a heat-conducting chimney, communicated through the container bottom into the space of the container lid when the container lid seals the container, for conducting combustion gases from the open flame when the flame is proximate the container bottom through the container without the combustion gasses entering into the container and into the space, the combustion gasses exiting through the one or more vents to produce a heated container bottom, the container bottom heated by the open flame; and b) communicating the combustion gasses through the chimney and through the space to exit through the one or more vents to produce a heated chimney and a heated container lid; and c) cooking a content of the container using the heated container bottom, the heated chimney and the heated lid.

The configuration, layout, and operation permits a multimode cooking system in which a specially configured pot and lid may cooperatively define both a direct cooking mode and a baking mode. The baking mode is not only efficiently enabled by multiuse of a single apparatus, but use of circulating hot gasses through specially adapted channels provides a better more efficient baking experience than conventional portable/backpack baking solutions while being lightweight without contributing to extra bulk.

### BRIEF DESCRIPTION OF THE DRAWINGS

FIG. 1 is a side plan view of a preferred embodiment of the present invention; and

FIG. 2 is a top plan view of the preferred embodiment shown in FIG. 1.

### DETAILED DESCRIPTION OF THE INVENTION

The present invention relates to a system and method for a portable, space and weight efficient cooking solution that permits baking and other alternative cooking solutions. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

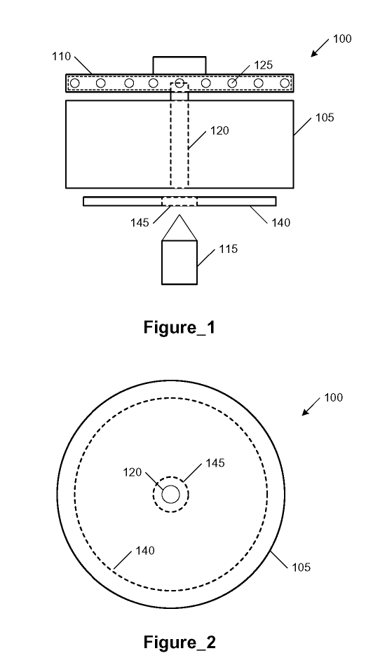

FIG. 1 is a side plan view of a preferred embodiment of the present invention for a system 100. System 100 supports different modes for cooking, including boiling and baking. System 100 includes a pot 105 and a cavity-defining double-walled lid 110 for use with a burning heat source 115. Pot 105 includes a chimney 120 defined by a heat conductive channel running from an opening in a bottom of pot 105 up and extending high enough from an inside of pot 105 to engage an opening in lid 110 when lid 110 seals a top of pot 105. Engaging the opening in lid 110 communicates gasses flowing through chimney 120 into the cavity defined within lid 110. Lid 110 includes one or more vents 125 permitting outflow of the gasses communicated into the cavity through chimney 125. Lid 110 includes a lid handle 130 for placement and removal. In the preferred embodiment, a heat shield 140 is disposed between heat source 115 and the bottom of pot 105 to moderate a temperature of the pot bottom. Shield 140 includes an aperture 145 generally aligned with chimney 120 to permit heated gasses to pass from heat source 115 past shield 140 (through aperture 145) into chimney 120 and then into lid 110 to outflow from vent(s) 125. FIG. 2 is a top plan view of a portion of the preferred embodiment shown in FIG. 1. FIG. 2 illustrates the general alignment of pot 105, shield 140, aperture 145, and chimney 120.

Pot 105 doubles as a cookpot and baking oven by virtue of the structure and arrangement described herein. Thus this one piece of cookware simply and efficiently enables a wide-range of cooking (for example the boiling and baking modes). Thus except for chimney 120, pot 105 conforms in many respects like conventional cookpots and may include non-stick surfaces, heat-conducting bottoms, and other arrangements without departing from the spirit of the present invention.

Lid 110 is arranged generally to function as a conventional lid when pot 105 functions as a cookpot when, for example, system 100 is in boil mode and to function as part of the baking configuration when system 100 is configured in bake mode. Lid 110 includes an opening generally aligned and engagable/sealable with chimney 120 to inhibit gasses passing through chimney 120 from entering inside pot 105. Rather these gases enter inside the cavity of lid 110 and are ejected from vent(s) 125. When these gasses are hot, the preferred embodiment provides that at least that portion of a wall of lid 110 sealing a top opening of pot 105 is heated by the gasses. In some embodiments, the entire lid 110 is heated so lid handle 130 permits safe handling while in other embodiment the topmost surface is heat insulated so the lid outside surface is relatively cool while the heated inner surface contributes to the cooking/baking experience.

Heat source 115 in the preferred embodiment is a heat source available to a mobile backpacker, such a burning flame from a gas stove or fire. In implementations for home stovetop use for example, heat source 115 may not be an open or burning flame. In any event, heat source 115 generates direct heat to pot 105 (particularly the pot bottom) and generates heated gasses.

Chimney 120 is, in the preferred embodiment, a single central generally circular channel but in other configurations, implementations, and embodiments, multiple channels and/or off-center channels, or non-circular channels may be implemented. Chimney 120 provides several important contributions to system 100: 1) in a baking configuration (for example with lid 110 installed on pot 105) it directs gasses from heat source 115 into the cavity inside lid 110; 2) it participates in the cooking modes as it becomes heated from the gasses passing from heat source 115 to lid 110; and 3) it helps prevent the heated gasses from entering inside pot 105 by providing a heat-conducting barrier channel, with the channel communicated directly to the cavity inside lid 110 in a preferred baking mode.

Vent(s) 125 are configured to permit heated gasses entering within the cavity of lid 110, such as from chimney 120, to exit the cavity. The number, pattern, and layout of vent(s) 125 is designed to facilitate the venting while helping to uniformly heat an underside of lid 110 to improve a heat contribution from lid 110 during the bake mode.

Shield 140 is shown as a separate, discrete element from pot 105 in the preferred embodiment. It is understood that in some configurations, implementations, and embodiments, different systems will be adapted differently, such as for example, to integrate shield 140 directly in the bottom of pot 105. One reason in the preferred embodiment to have shield 140 separate and apart from pot 105 is to improve the multimode operation. Without shield 140 disposed between heat source 115 and pot 105, heat source 115 is able to more directly and more intensely heat the bottom—which is advantageous in many modes such as boiling or “pot cooking” and the like. However, for a baking mode, it is desirable to provide an even, enveloping heating arrangement of the baking apparatus. Since chimney 120 and lid 110 are being heated by gasses generated from heat source 115 rather than by direct heating, without shield 140 in place for some baking configurations, the bottom of pot 105 would be hotter than the other components creating an undesirable temperature imbalance.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures may also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A cooking apparatus for use with a burning heat source, comprising:
a heat conductive container having a container bottom and a container sidewall extending upwardly from said container bottom to form a container opening;
a container lid generally sealing said container opening, said container lid including a double-wall defining a space including one or more vents communicated outside said container; and
a heat-conducting chimney, communicated through said container bottom into said space of said container lid when said container lid seals said container, for conducting heated gasses from the burning heat source when the burning heat source is proximate said container bottom through said container without said heated gasses entering into said container, said heated gasses entering into said space and exiting through said one or more vents.

2. The apparatus of claim 1 further comprising a heat-shield disposed between the burning heat source and said container bottom.

3. The apparatus of claim 2 wherein said chimney defines a first aperture in said container bottom and wherein said heat shield includes a second aperture generally aligned with said first aperture for communicating said heated gasses into and through said heat-conducting chimney.

4. A cooking method, comprising:
a) supporting a container over a burning heat source, said container including: a heat conductive wall defining a container bottom and a container sidewall extending upwardly from said container bottom to form a container opening; a container lid generally sealing said container opening, said container lid including a double-wall defining a space including one or more vents communicated outside said container; and a heat-conducting chimney, communicated through said container bottom into said space of said container lid when said container lid seals said container, for conducting heated gasses from said burning heat source when said burning heat source is proximate said container bottom through said container without said heated gasses entering into said container and into said space, said heated gasses exiting through said one or more vents to produce a heated container bottom, said container bottom heated by said burning heat source;
b) communicating said heated gasses through said chimney and through said space to exit through said one or more vents to produce a heated chimney and a heated container lid; and
c) cooking a content of said container using said heated container bottom, said heated chimney and said heated lid.

5. The cooking method of claim 4 further comprising:
d) disposing a heat shield between said burning heat source and said container bottom to reduce a temperature of said container bottom.

6. The cooking method of claim 5 wherein said chimney defines a first aperture in said container bottom and wherein said heat shield includes a second aperture generally aligned with said first aperture, the method further comprising:
e) communicating said heated gasses from said burning heat source through said apertures into and through said chimney.
